(19) United States
(12) Patent Application Publication
(10) Pub. No.: US 2014/0006527 A1
(43) Pub. Date: Jan. 2, 2014

(54) METHOD, SYSTEM, AND COMPUTER PROGRAM FOR PROVIDING AN INTELLIGENT COLLABORATIVE CONTENT INFRASTRUCTURE

(71) Applicant: Sara Winter, Toronto (CA)

(72) Inventor: Sara Winter, Toronto (CA)

(21) Appl. No.: 13/720,292

(22) Filed: Dec. 19, 2012

Related U.S. Application Data
(60) Provisional application No. 61/577,117, filed on Dec. 19, 2011.

(51) Int. Cl. H04L 12/58

(52) U.S. Cl. CPC H04L 51/32
USPC 709/206

(57) ABSTRACT

The system of the present invention provides social media platform that enables facilitator or parent to guide one or more users, usually the children, to engage in facilitated social communications. The parent through a facilitator area may post content to a social communication landing page configured for the child or children, and also configure a matching facility, in a manner that is designed to enable social communications in the child or children who have social communication obstacles. The system is operable to monitor actions of the child or children within the social networking environment provided by the social medial platform, including for the purposes of dynamic modification of social networking parameters to continuously build on the comfort level of the child or children in engaging in social communications.

### FIELD OF THE INVENTION

The present invention relates to social networks, and more particularly social networks adapted for use by children having a developmental disability.

### BACKGROUND OF THE INVENTION

It is estimated that approximately 67 million people in the world are autistic. Some studies indicate that one in 70 boys is autistic. Also, in the last three years, global incidence of autism has increased from one in every one hundred and fifty children to one in every one hundred and ten. It is believed that autism or ASD is the fastest growing developmental disability, having 10-17% annual growth.

Autism generally requires support can be quite expensive. According to a 2007 study out of Harvard University, a person with autism can cost roughly $3.2 million in autism-related expenses throughout a lifetime.

Children on the autism spectrum have been shown to be bullied at a rate of 93%.

Kids with autism process sensorial information differently which leads to a lot of difficulty in communication. They often spend their entire day learning to manage environments that are counter-intuitive to the way their brain processes information. Their daily routine can be divided into three categories and therefore directly influence social opportunity and experience.

First, there are the children who are in autism classrooms. These children typically go to school with 8 to 12 of their peers based on having a diagnosis of ASD. They generally have a huge range of social and cognitive abilities. Also, because of the small sample of kids they have access to every day, these children may not share a special interest or experience with their fellow students. For example, let us take the example of Ben who is 12 and is quite affected by autism. He is at his most available to make connections with his peers when he plays basketball, and has a specific framework under which he can make social interactions. Ben is in a class with Adam, who is ten years old and extremely musical but struggles with sports. When he plays basketball with Ben, he often shuts down and operates in an almost completely in “fright-flight” mode, with very little access to the executive functioning of his frontal lobe, and has little ability to communicate.

Second, are the children who are “mainstreamed”. Research suggests that these children are being bullied at a rate of 93%. On any given day, they are also being asked to complete their academic work in an environment that is not ideal for kids with sensory processing issues. Lighting, an excess of verbal communication, tacile defensiveness and olfactory concerns are all issues that these kids face every day, leaving them little resources to make social connections. Moreover, they are often the only child in their class (sometimes even their school) having these experiences.

Third, are the children who are home schooled. These children spend most of their time with their primary caregiver or their parent leaving little opportunity to interact with kids their own age. This presents two key obstacles. First, communication between them and their parent or caregiver becomes stagnant; many parents can tell their child how proud they are of them, but after awhile, it loses it potency. Second, the children on the autism scale are generally more isolated from other kids, leaving them feeling even less competent in social interactions and the idea of friendship. Children with autism often struggle with self-esteem and sense of self, defining themselves by what the adults around them say about them. These children often have special interests that adults find difficult to validate and experience in the way another child would.

The prior art approaches, based on therapeutic play dates for example, are not scalable, and are costly. These visits at best are usually once a week and since each time is a new experience, kids have little ability to encode any feelings of competency between visits and have less ability to build their level of competency with the idea of friendship.

Very few online resources are available that address the needs of children with autism, and in particular enable a therapeutic use of technology or social media.

There are a number of social platforms developed for children on the autism spectrum, however, these are therapeutic in nature and are not recreational.

ModelMeKids™ distributes a therapy-based software tool to teach social skills through video modeling, however, this solution is therapeutic nature and does not conceive of therapeutic benefits realized through social recreational activities using social media.

Special Playdate™ provides an online matching service for children with special needs.

Social media are very popular amongst various demographic groups, including children. “Friending” through social media can help children to feel included, and allows them to learn from their peers. However, for a variety of reasons, existing social media is not well suited for use by children who are autistic.

Children however need a break from therapy and need to build sense of self. Children on the autism spectrum are often creative and technology savvy and the prior art solutions with the “therapy” feel and lack of sophistication.

Prior art social media technologies designed for children such as Togetherville™ or New Moon Girls™ generally require faster processing time which may cause children with autism for example to move quickly through these sites quickly for “click gratification” much like they would in gaming, without getting a chance to encode the experience and to transfer what they've experienced into their daily life. In other words, these prior art solutions are not suitable in helping children on the autism scale for example to overcome their social communication obstacles.

A social media engine and social media engagement method is required for children on the autism scale. Particularly given the bullying that children with autism are suffering, and also the difficulties that children with autism can experience in forming social relationships, the need for such a social media engine and social media engagement method is great.

### SUMMARY OF THE INVENTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

In one aspect of the invention, a computer implemented system is provided for enabling social communications involving one or more individual with social communication obstacles comprising: (a) one or more computers including or being linked to a server computer, the server computer implementing a server application, the server application being in communication with one or more electronic communication devices; (b) the server application being operable to define a social networking website that defines a facilitator area associated with one or more facilitators, and at least one social communication landing page associated with one or more users, in which the facilitator area enables the placement of content by the one or more facilitators into the social communication landing page, and guidance and monitoring of social communications by the one or more users with one or more other users associated with the social networking website; and (c) the server application further defining a matching utility that is configurable by the one or more facilitators from an electronic communication device so as to define one or more filters for matching the one or more users with one or more other users of the social networking website who may be compatible to elicit social communications with the one or more users.

The system of the present invention provides social media platform that enables a facilitator or parent to guide one or more users, one or more children on the autism spectrum, to engage in facilitated social communications. The parent through a facilitator area may post content to a social communication landing page configured for the child or children, and also configure a matching facility, in a manner that is designed to match the child or children with other users who based on their profile and matching settings defined by the facilitator may be compatible with the child or children for the purposes of social and recreational communications despite social communication obstacles. The system is operable to monitor actions of the child or children within the social networking environment provided by the social medial platform, including for the purposes of dynamic modification of social networking parameters to continuously build on the comfort level of the child or children in engaging in social communications

The social networking environment of the present invention enables the encoding of the current progress of the child through the social communication landing page and also the facilitator dashboard. Parents and children can change their settings as often as they like, keeping the experience dynamic and scalable. Parents have access to all of the data from the reporting section of their dashboard.

In one aspect, a computer implemented system for promoting social networking communications involving one or more users facing social communication obstacles comprising: one or more computers including or being linked to a server computer, the server computer executing a server application, the server application being in communication with one or more electronic communication devices; the server application defining one or more social networking Internet sites (“social networking site”) that include a facilitator area accessible to the one or more facilitators, wherein the server application: (i) enables the one or more facilitators to place content for the one or more users in a social communication landing page (ii) enables the one or more facilitators, using a matching utility, to manage the matching of the one or more users to a set of other users with whom the one or more users may be compatible for engaging in social communications (“matched users”); and (iii) enables the one or more facilitators to monitor activities of the one or more users through the social networking site, and if it is determined that this is advisable, guide the engagement of the one or more users with the matched users, using social networking communications; wherein the server application permits the one or more facilitators to provide a facilitated social networking experience to the one or more users.

In another aspect of the invention the server application includes or is linked to a profile manager, wherein the profile manager maintains for each user a profile that includes information based on at least one assessment or diagnosis of the user that is relevant to social communication or user of social networking.

In another aspect, the assessment or diagnosis is based on placing the user on an autism scale.

In another aspect, the system implements one or more rules for promoting objectives regarding social networking communications (including increased comfort levels with social networking communications), dependent on the assessment or diagnosis for the one or more users.

In another aspect, the system is configured to adapt: (a) the content; (b) social networking features or functions; or (c) matching functions; based on monitoring the activities of the one or more users, and applying the rules.

In another aspect, the system permits the one or more facilitators to manage a curated Internet area where the one or more facilitators can post positive messages that instill positive feelings for the one or more users.

In another aspect, the server application implements one or more features that enable the one or more facilitators to post content that is familiar to the one or more users.

In another aspect, the system permits the tuning of matching operations of the matching utility including based on common interests, age, gender, whether the user uses a label for their diagnosis, or whether the user uses the system with a caregiver or independently.

In a still other aspect, the one or more facilitators may include a therapist.

In another aspect, the rules include the requirement that certain changes intended by a facilitator, optionally depending on the profile of the user, requires approval by a therapist user of the system.

In another aspect, the rules are based on validated scientific research for promoting social communication or learning objectives in users.

In another aspect of the invention, the system adapts the content or messaging operations to reduce stimuli to avoid over-stimulation or anxiety in the one or more users.

In a still other aspect of the invention, the system: (a) analyzes the social communications of the one or more users; and (b) provides one or more reports to the one or more facilitators regarding the social communications of the one or more users.

A computer implemented method of promoting social networking communications of one or more users who face social communication obstacles is provided comprising: (a) one or more facilitators using a server application to configure for the one or more users one or more social networking Internet sites (“social networking site”); (b) the one or more facilitators placing content for the one or more users in a social communication landing page; (c) the one or more facilitators using a matching utility to match the one or more users to a set of other users with whom the one or more users may be compatible for engaging in social communications (“matched users”), where the matched users consist of a finite group of users to avoid overwhelming the one or more users; and (d) monitoring the activities of the one or more users through the social networking site, and if it is determined that this is advisable, guiding the engagement of the one or more users with the matched users, using social networking communications, so as to provide a facilitated social networking experience to the one or more users that promotes social communication or learning objectives.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a diagram illustrating a representative social network enabled by the present invention.

FIG. 2 is a system diagram illustrating the system architecture of the present invention.

FIGS. 3a to 3h show a series of representative user interfaces or screens presented by the platform of the present invention.

FIGS. 4a to 4g show a series of management interfaces presented by the present invention for defining certain user settings, and uploading information to the platform of the invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

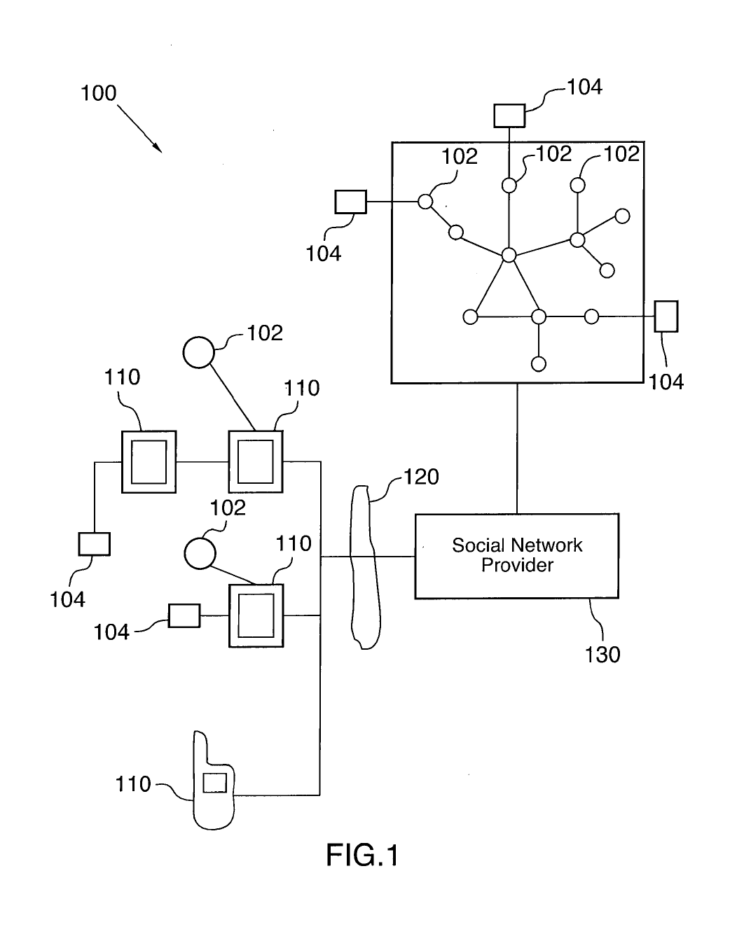

FIG. 1 illustrates an exemplary environment 100 for enabling social and recreational communications in a social network for one or more users 102, facilitated by a facilitator 104. The facilitator may be an adult 104, and possibly a therapist, a teacher, or often a parent who has obtained knowledge regarding facilitating the social interactions of individuals with social communication obstacles, whether from the operator of the environment 100 or otherwise.

Users 102 may be children, young adults, or even adults, who may benefit from facilitation in regards to their social interactions with others, be this encouragement, setting up of a user associated social environment or “wall”, helping select appropriate “matches” with other users for social and recreational communications, and so on. Possible workflows associated with the facilitation of social interactions are provided below.

A social network is generally defined by the relationships among groups of individuals, and may include relationships ranging from casual acquaintances to close familial bonds. A social network may be represented using a graph structure. Each node of the graph corresponds to a member of the social network. Edges connecting two nodes represent a relationship between two individuals. In addition, the degree of separation between any two nodes is defined as the minimum number of hops required to traverse the graph from one node to the other. A degree of separation between two members is a measure of relatedness between the two members.

Various communities struggle with social communication and this can produce isolation and even depression, and moreover can limit the integration of the members of the community with society as a whole. This in turn undermines the ability of the members to receive education or to find certain types of employment, even though the contributions that can be made by individuals with autism are generally very significant.

The inventors have realized that individuals with social communication obstacles, such as individuals having ADHD, SPD, FAS, and so on, can benefit greatly from a facilitated social networking experience. Especially if a facilitated social network is provided to such individuals when they are children then social communication obstacles can be overcome or diminished. The present technology provides significant benefits to members of these communities, their families, and society as a whole.

As shown in FIG. 1, one or more users 102 namely, 102A-102N, at user devices 110, are coupled to a social network provider 130 via a communications network 120. In various embodiments, user devices 110 may include a computer terminal, a personal digital assistant (PDA), a wireless telephone, a digital camera, and so forth. In various embodiments, the communications network 120 may include a local area network (LAN), a wide area network (WAN), a wireless network, an intranet, an internet, and etc.

Notwithstanding the foregoing, in one embodiment of the invention, the social networking environment 100 is designed to be used by users 102 as a desktop application in order to promote ten-digit typing where possible. This is because this creates something called differentiation in the brain and consequently inter-hemispheric integration, putting the children in the best possible physiological state to be regulated and calm. In one embodiment of the invention therefore it should be understood that the system and computer program of the invention consists of a downloadable program that provides the features described that are accessed by the users. The facilitator may also download a complementary program that enables the facilitator to define settings associated with the application downloaded for the user, and also enable communication as between the facilitator and the user, including as described in this disclosure. The desktop application may connect to the social network provider 130 for accessing the matching functions described, and to connect the users to “friends” through the facilitator provided by facilitator. It should be understood that the present invention contemplates various computer and network architectures for enabling the features and functions described, and the invention should not be read to be limited to any particular computer or network implementation. If the facilitator and the user are using the same computer then a single desktop application may be downloaded, where for example the facilitator signs in using a username and password to access facilitator functions described. Alternatively, the facilitator and the user may use separate computers, in which case the facilitator instance of the application is configured to enable interoperation with the user instance of the application, as described, using a variety of mechanisms including for example networking of the user devices associated with the facilitator and with the user, or using the web server as an intermediary for facilitating posting messages to the user environment, or posting content such as photos. It should be understood that for security reasons, it is desirable that the content associated with the user be stored on a computer that is within the user's environment, and that the user controls. The concept of content being stored in the cloud for example, even if subject to access control can be frightening to users. The interaction of “friends” through the social networking environment created by the present invention, may be enabled for example based on permitting “friends” to access and interact with selected content that is resident on the user device, for example by operation of remote access technologies implemented using the web server of the present invention.

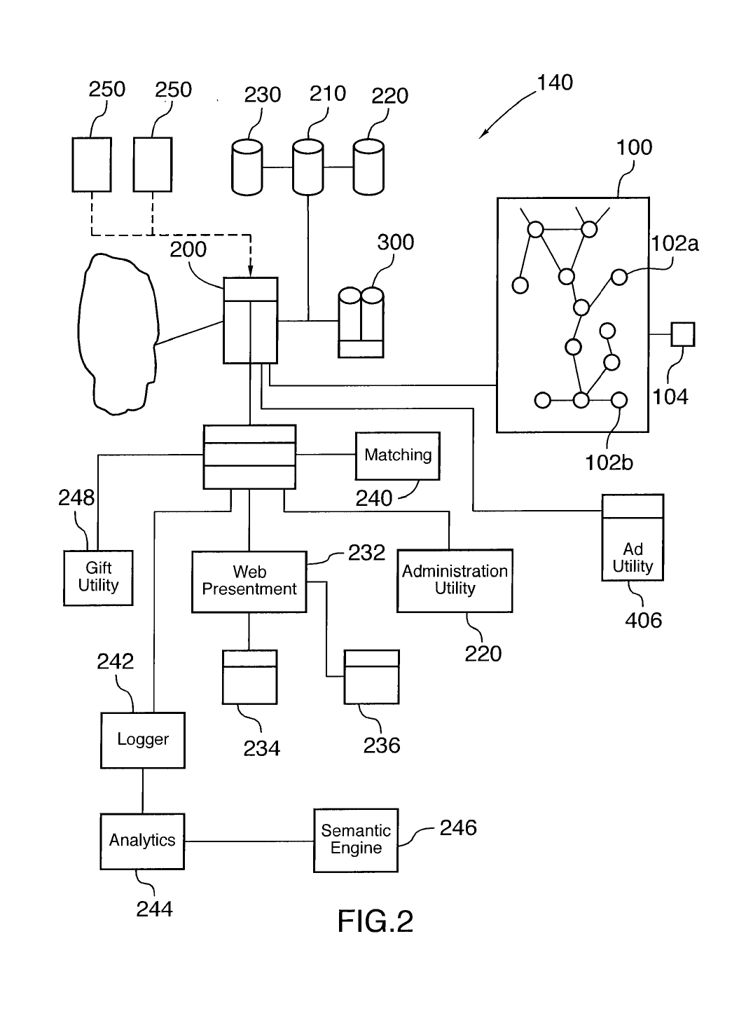

A particular embodiment of a facilitated social network is illustrated in FIG. 2. This particular embodiment illustrates the application of the technology of the present invention for enabling one or more adults 104 to assist one or more children 102 who are on the autism spectrum to engage in social and recreational communications using a social network. Children on the autism spectrum find the use of traditional social media platforms difficult if not possible, however, can benefit greatly from the socialization that the social network of the present invention allows them to access.

FIG. 1 illustrates a graph representation of a social network centered on a given individual.

FIG. 2 is a block diagram illustrating a system for creating and managing an online social network. As shown, FIG. 2 illustrates a system 140, including an application server 200 and graph servers 202. The computers of system 140 are connected by a network 204, e.g., the Internet, and accessible by over the network by a plurality of computers 110. The application server 200 manages a member database 210, a relationship database 220, and a search database 230.

The application server 200 includes a web presentment utility 232. The web presentment utility 232 may be a standard utility or set of utilities operable to present one or more web pages based on the workflow or social interactions described herein.

As illustrated in FIG. 2, the system of the present invention is operable to provide a web area or web site for the facilitator, also referred to as facilitator area 234. In some embodiments of the invention, this web site may be implemented as a parent website in which one or more parents may help facilitate or media the social or recreational communications of one or more children, usually their child or their children having social communication obstacles. The facilitator area 234 enables the facilitator, for example a parent of a child with autism, to monitor and track the activities of their son or daughter, and to facilitate in an innovative manner engagement of their children in social and recreational communications, utilizing an easy-to-use dashboard associated with the facilitator area 234.

The member database 210 is administered on the system side by a known administrative utility 235 used to manage access to the various functions of the system, and to define the resources accessible to particular users and user types. The administrative utility 235 defines a profile for each facilitator in the member database 210 and assigns the functions and resources assigned to the particular facilitator, and also defines the one or more users 102 associated with a particular facilitator, and the features and functions of the system available to user or users 102. Optionally the administration utility may embody one or more rules that define the discretion that facilitators may have in facilitating the social interactions of users. For example, the administration utility, in a particular embodiment of the present invention, may for example require facilitator to operate in accordance with rules associated with the one or more users, and may only override such rules if this is approved for example by a therapist associated with the operator of the environment 100, or who has provided credentials to the system 140 previously. Many other embodiments are possible in which particular rules are established to help ensure that the facilitation of social interactions of users 102 meets the objectives that have been established, which may include best practices for achieving therapy benefits in regards to social interaction, based on the particular condition of the user 102 for example.

It should be understood that the science on such matters is evolving, and one advantage of the present invention is that the administrative utility 235 and other resources of the application server 200 may be updated regularly to ensure that the operations enabled by the system 140, and the social media environment 100, reflect current scientifically validated method for enabling positive changes in the ability of users 102 to engage in social interactions, and also avoiding harm to users 102.

Once a facilitator 104 for example a parent, registers and is approved to be part of the social networking environment 100, the facilitator 104 is invited to set up the social communication landing page 236 of their assigned user or users 102, which may be configured by the facilitator and based on the configurations made by the facilitator, and based on the parameters defined by the administrative utility 235. The social communication landing page 126 is presented by operation of the web presentment utility 232. The social networking environment is best understood as consisting of the social communication landing page, tied to social networking functions enabled by the web server of the present system. The social networking landing page is connected to a series of sub-pages. All of these pages, may be implemented using a clean, uncluttered, and simple design aesthetic in order to appeal to children on the autism scale, who strongly prefer order.

In one embodiment of the invention the social network environment 100 is branded as the Squag™ community, and the social communication landing page configured for the user(s) 102 is branded as the Squagpad™. In one implementation of the invention, the facilitator 14 may curate the content associated with the Squagpad™. The content may consist of any manner of digital content, including text, audio, graphical content, video content and so on, configured in accordance with one or more web pages including arrangements of content, and navigation between related web pages.

The purpose of the social communication landing page 236 is to create a facilitator curated web area where the facilitator may post positive messages and content that will resonate with the user 102 and instill positive feelings.

The application server 200 includes or is linked to a security utility 238 that is operable to prevent unauthorized access to web pages maintained within the social networking environment 100. The security utility may implement best of breed Internet security mechanisms. This is in part to avoid feelings of violation that would result from hacking of the social communication landing page 236 of a user 102, which may be particularly harmful in the user base referred to above having for example autism. Also, the social networking environment 100 may be configured to adhere to one or more rules meant to limit the risk of positing of content to a social communication landing page 236 that may be inappropriate. For example, in on aspect, file sharing of any kind is prohibited by the administrative utility 235 for this reason.

Generally speaking, the facilitator 104 will configure the Squagpad™ such that when a user arrives s/he is surrounded by their favourite things that represent the user, and that provide the user with positive feelings. The Squagpad™ is configured to enable the user 102 to watch videos, browse photos, and write in their journal. They scroll over their “room”, see positive messaging from their parents, and use them to create original thoughts about themselves.

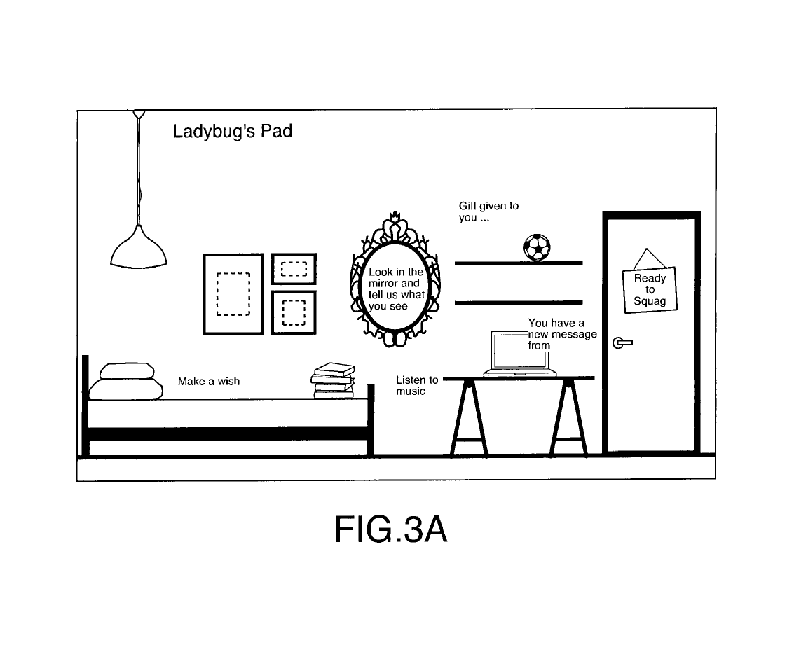

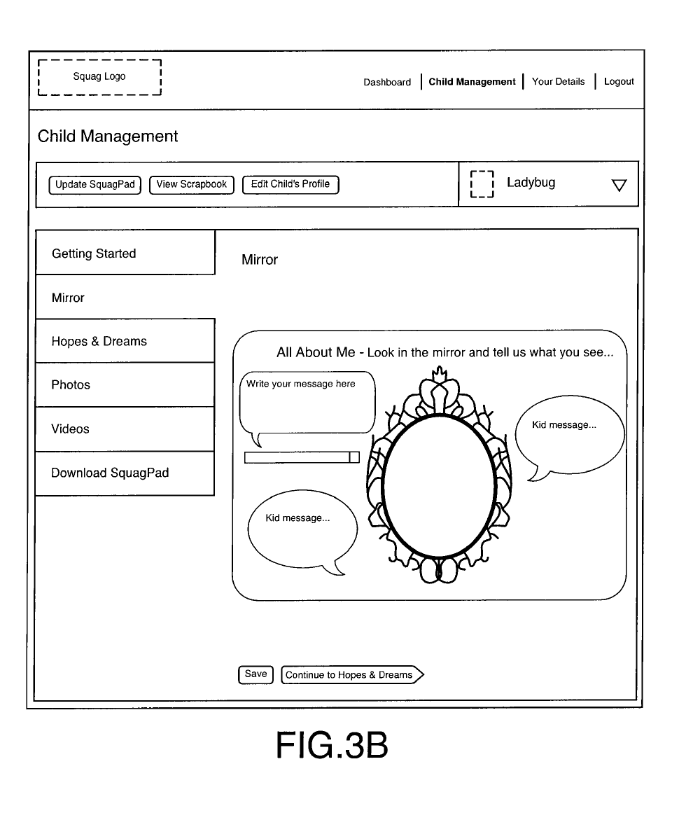

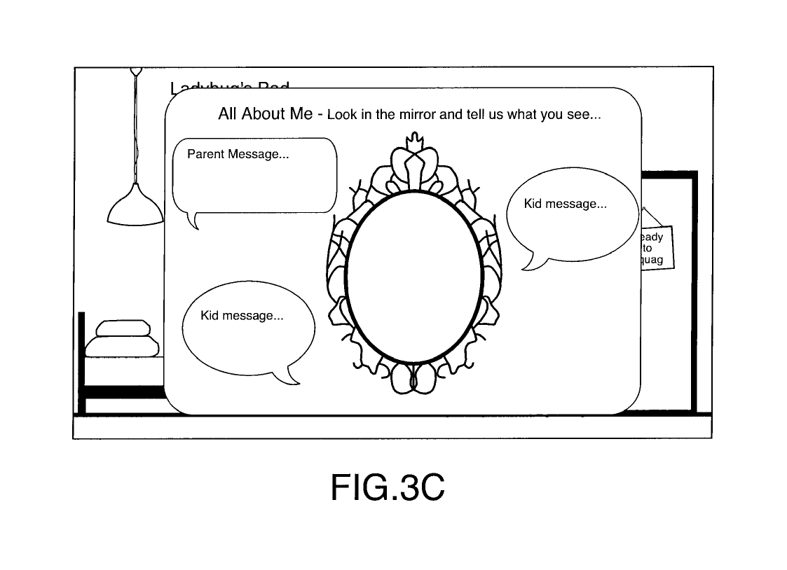

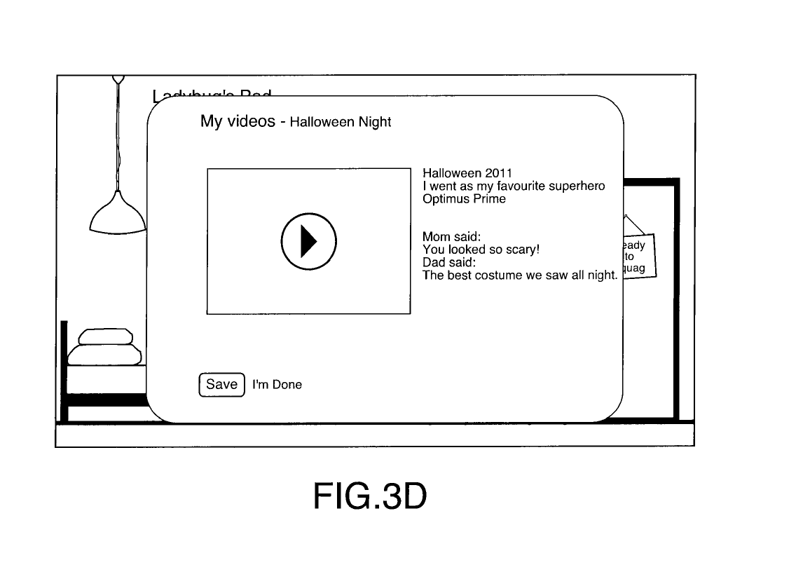

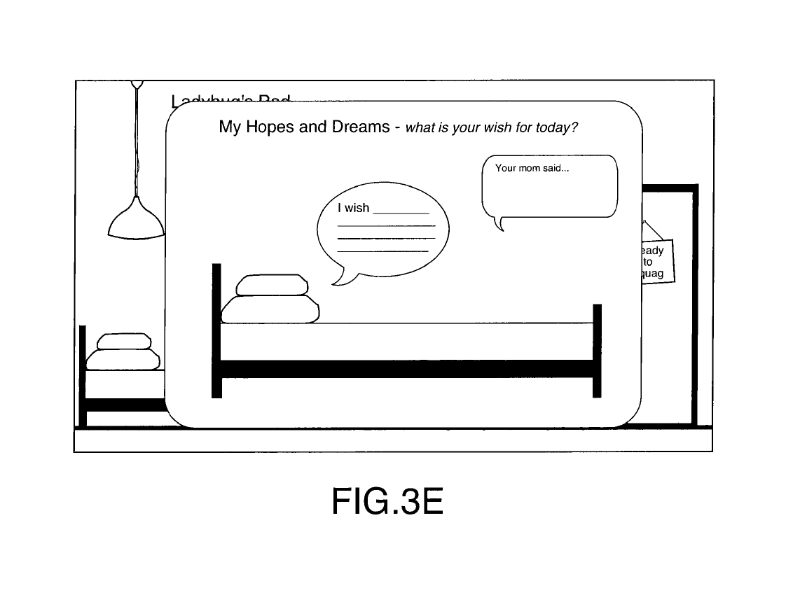

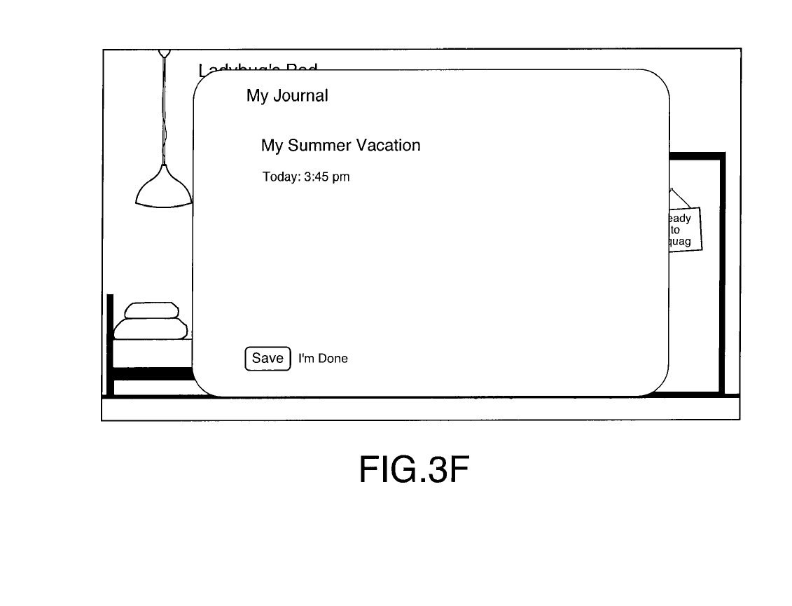

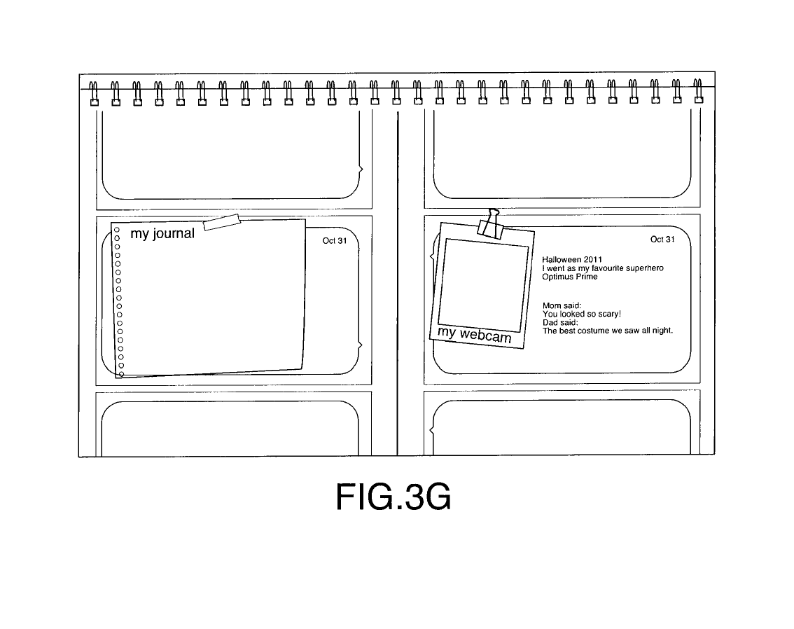

FIG. 3a illustrates a particular embodiment of the invention, showing an example of the implementation of the social communication landing page 236, namely a particular graphic user interface enabling a user to interact with a series of functions associated with the social communication landing page 236. The user may listen to music, look at photos and write in their journal, and see positive messages from their facilitator (usually their parents). The user may use these elements as a springboard to create original thoughts about themselves. Each time the user makes a contribution, they have the option to post it to their “scrapbook” which sits on the shelf of their Squagpad™ and becomes the visual communication between parent and child.

In one aspect of the invention, the first step in initiating social communications generally involves creating the Squapad™ and then providing the user 102 an opportunity to become comfortable with the environment. When the room is ready, then in one embodiment of the invention, the user 102 may indicate willingness to initiate social communications via the social networking environment and the facilitator 104 feels that the user 102 is ready for social communications, the facilitator 104 initiates a function of the facilitator area 234 to initiate an innovative matching operation enabled by a matching utility 240 that is part of or linked to the application server 200. In one aspect of the invention, the matching utility 240 is operable to offer a small sample of other possible users 102b, 102n for user 102a to interact with through social and recreational communications, mediated by the social networking environment 100.

Generally speaking, with individuals who have social communication obstacles, to overcome those obstacles it is important to ensure that the user is not overwhelmed, and therefore the open ended traditional social networks, where invitation from potential friends can spike, and there the social network can grow quickly, to a point that the user may initially be comfortable with, but that ultimately overwhelms the user. This is avoided by ensuring that the number of potential social matches presented to the facilitator is a manageable amount. The amount determined may be based on the profile of the user 102, which includes in part information regarding the user's condition. Further aspects of dynamically configuring operations of the social networking environment 100 to the then current state of a particular user 102 are explained below.

In a particular implementation of matching utility 240, the facilitator 104 may control, using one or more drop down menus presented within the facilitator area 234 for example, the parameters for matching the associated user 102 with other users. In this way, the facilitator 104 may “tune” the matching operations based on their knowledge of the user 102 and the status of their social communication obstacles at the time. The matching operations may modified by the facilitator for example to match based on for example common interests, age, gender, whether or not they use a label for their diagnosis, and whether or not they use the application with a caregiver or independently. Depending on how wide or narrow the array of Squaggers™ that the parent wants their child to have access to, they can customize where their child's starting point is within the social networking environment. For example: the parent may or may not choose to suggest special interests that their child may have, specific behavioral characteristics that may affect the way their child uses the application, certain experiences (like bullying) the child may have had at school or in other mainstreamed environments. The more specific the parent is during this matching process, the more customized their child's Squagpad™ will be. Parents can change their settings as often as they like to keep the process dynamic and working incrementally toward the child's feelings of independence.

Further embodiments of the matching utility 240 are explained below.

The user 102 may be presented with the list of potential fellow Squaggers™ that are matched with the user 102. The user 102, in one embodiment, may select one or more of the matched Squaggers™ and view information regarding the one or more of Squaggers™ or potential friends. If the potential friends accept, then the other users 102b, 102n are linked to the first user 102a through their respective profiles.

In a particular embodiment of the invention, once a friend connection is made by operation of the social networking environment 100 of the present invention, the respective social communication landing pages of users 102a, 102b pop up together, and the original thoughts created by each as part of their social communication landings pages are shared through this interface and become available to spark conversation.

In accordance with this aspect of the present invention, the display of the social communication landing pages 236 of the users engaged in social communication via the social networking environment 100 creates a sense of trust in that each of the users knows that the other user is able to access the same amount of information about them as they are about the other user. In addition, the display of the content from both users within a single screen allows the user to explore similarities and differences in the content posted, and use this as a starting point for conversation.

In a particular embodiment of the invention, social communications enabled by the social networking environment 100 of the present invention are always or primarily one-on-one, based on one or more matching parameters defined by the facilitator 104.

The social networking environment 100 of the present invention enables users who would ordinarily because of their social communication obstacles be uncomfortable engaging in social networking, find social interactions via the social networking environment 100 of the present invention comfortable.

In another particular embodiment of the invention, the application server 200 includes or is linked to a gift utility 248 that is operable to enable users to select from a menu of digital artefacts, which one user may send to another user in order to then for example place the digital artefact within the room of the recipient user, for example, the shelf representation shown in the social communication landing page depicted in FIG. 3a.

FIG. 3b shows a representative sub-screen related to the social communication landing page. The mirror representation shown in FIG. 3a includes a photo of the user that the user likes. The sub-screen shows that the photo is used by the user to post positive messages and also for selected other individuals to post positive messages, usually the facilitator only. The system may impose restrictions on the number of messages that may be posted, in order to maintain an uncluttered interface. Also, messages may require facilitator permission prior to being posted to an important area such as the mirror sub-screen that the user identifies with himself/herself and plays an important role in building confidence and self-appreciation.

FIG. 3c illustrates that in one embodiment friends of the user may also be permitted to post messages to the mirror sub-screen.

It should be understood that for example the photos on the wall of the social communication landing page illustrated for example in FIG. 3a may enable the user or friends of the user with access rights, to link to one or more associated photo albums. The system provides access to one or more web pages that enables the user to select images and to upload images for sharing with others. The facilitator in another aspect of the platform may post images to the user's library with suggestion for the user to consider sharing same. Positive messages about the user and/or the images may be associated with the images.

As shown in FIG. 3d, the social network enabled by the present invention may also enable users to share video content with others, again through an uncluttered, structured interface.

FIG. 3e illustrates another function of the social communication landing page, namely an interface where the user and the facilitator, usually the parent, can share messages regarding the child's wish for the day. In one embodiment, this interface is represented by a bed on the social communication landing page, which links to a sub-page represented in FIG. 3e where the child expresses his/her hopes for the day. The bed representation may be used to convey the metaphor of the child expressing these thoughts at the beginning of their day as they wake up, in a safe environment that they are familiar with and is associated with feelings of comfort. The system may be operable to remove these messages after expiry of a particular period of time. This screen may link with a further screen presented by the facilitator area 234 that enables a parent to view the “hopes and dreams” of any associated users. Subject to a maximum character counts, the parent may also insert a comment or message for display on the social communication landing page 236

FIGS. 3f and 3g illustrate the online journal writing functionality of the invention, which may be incorporated into the features of the social communication landing page or be linked thereto. Users may post short journal messages about their experiences or events, and these may be posted to a calendar like interface, organizing the message for a day in the appropriate calendar spot, as shown in FIG. 3g.

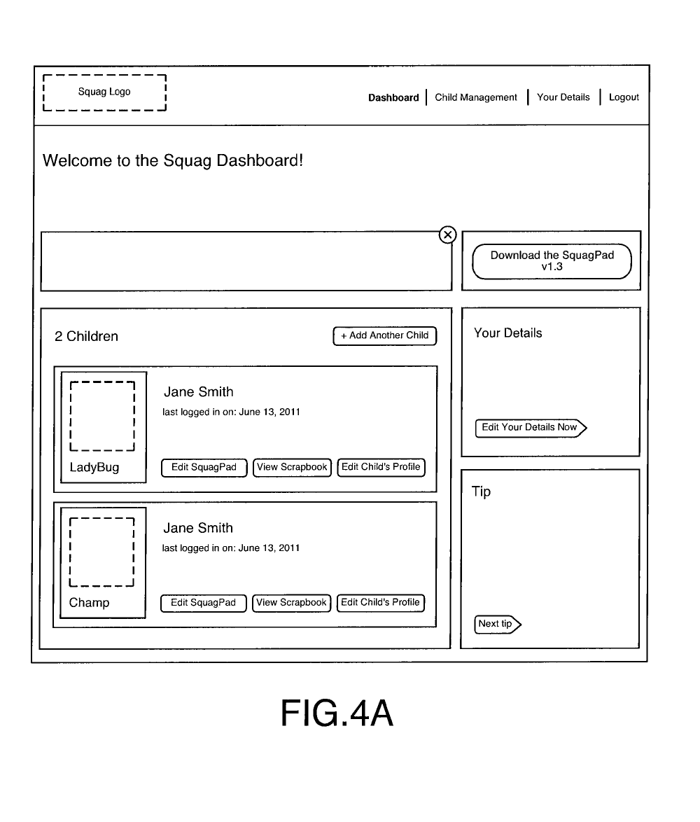

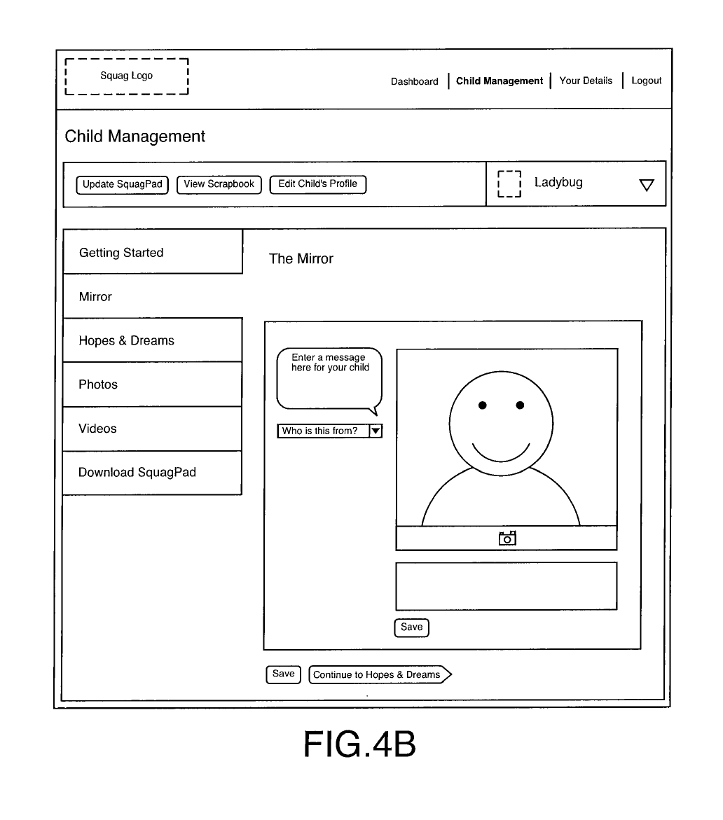

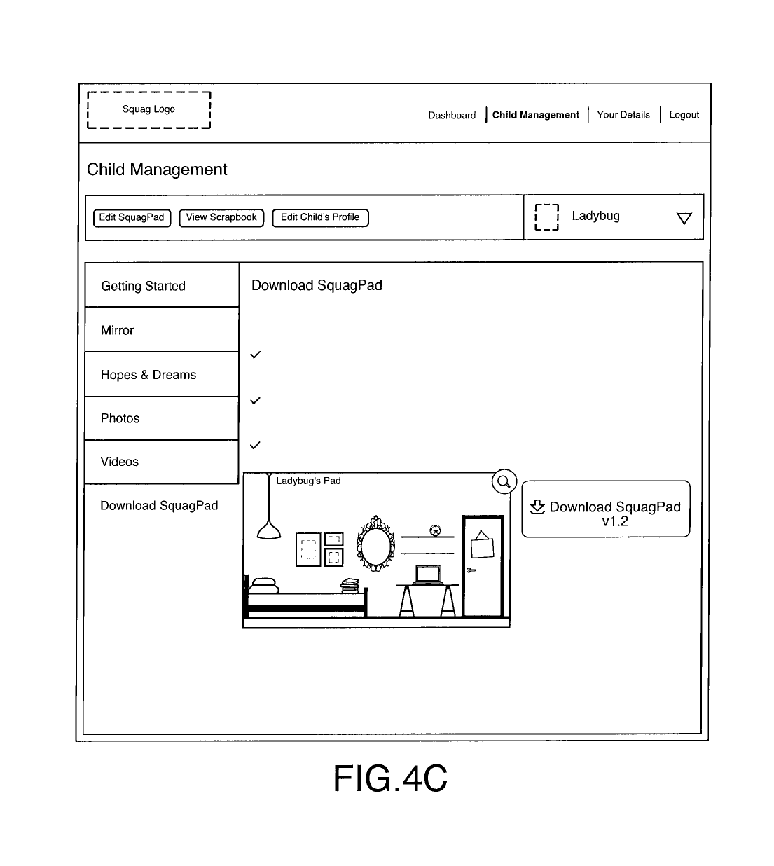

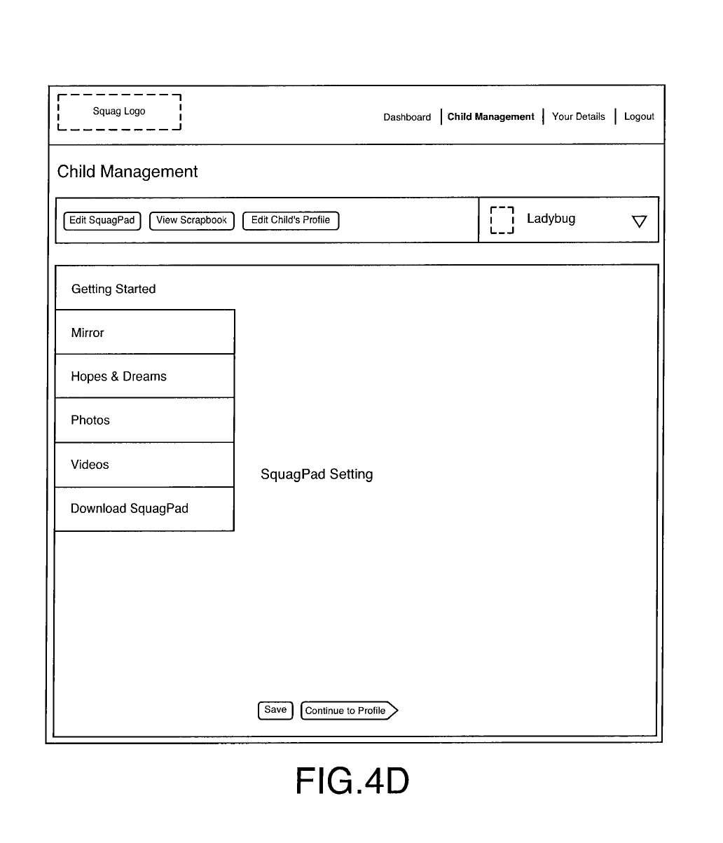

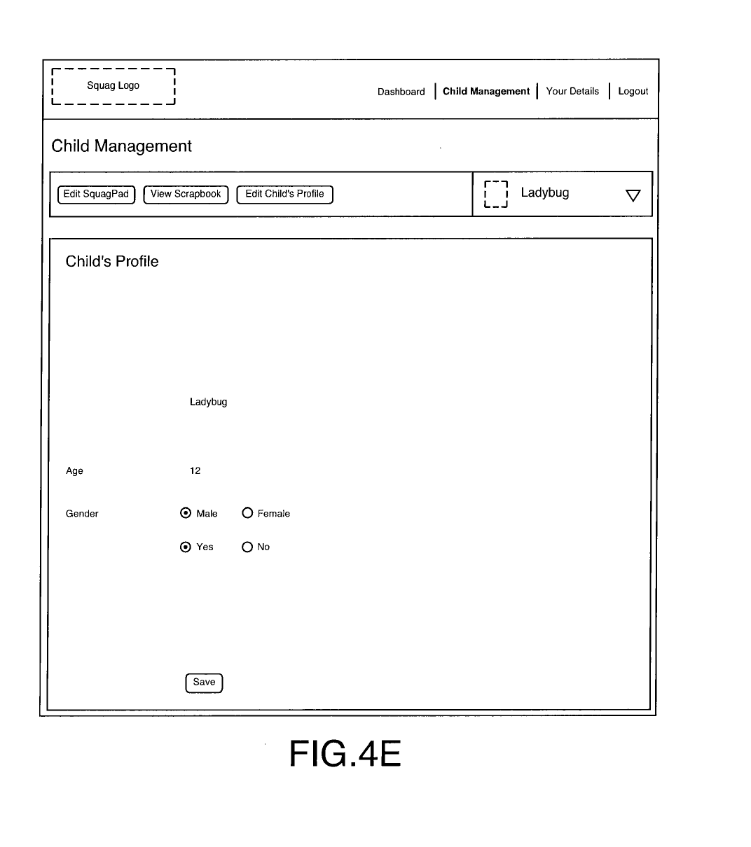

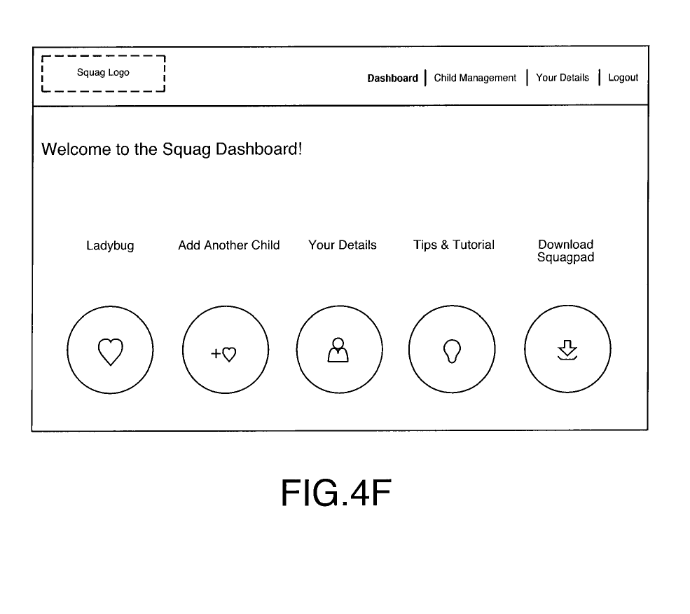

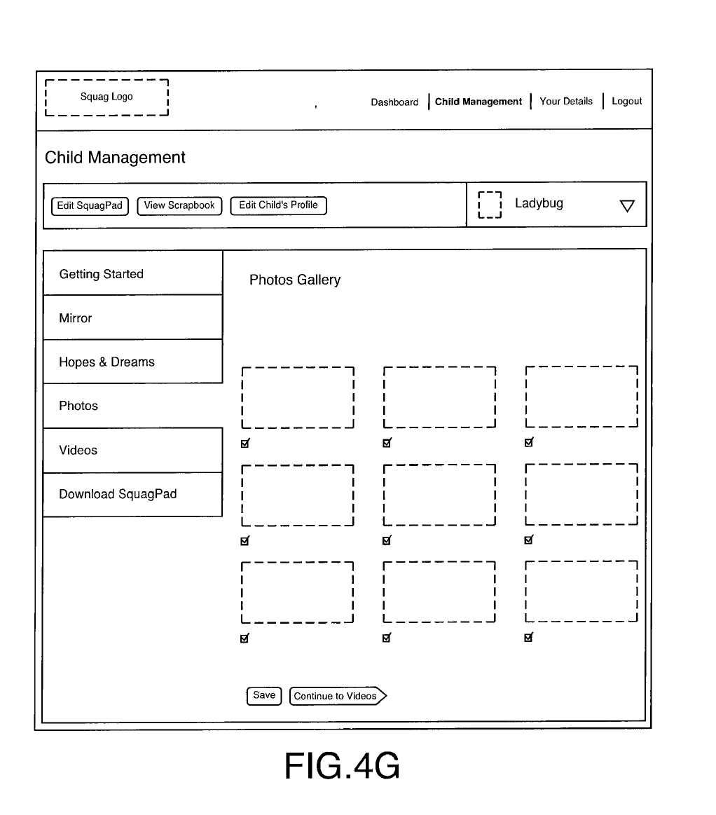

FIG. 4a illustrates a representative embodiment of the invention, and more specifically a screen presented by the system of the present invention that is part of the facilitator area or dashboard 234 enabled by the present invention. In the screen shown in FIG. 4a, one or more functions are presented for enabling the facilitator to define one or more settings related to the operation of the social networking environment, including (i) providing information regarding the one or more children, (ii) designing each child's social communication landing page, and uploading content for same, and (iii) establish and edit the child's profile. The screen also enables the facilitator to access one or more instructions for guiding the facilitator through the set-up steps. Also, the dashboard illustrated in FIG. 4a may provide access to one or more resources including for example articles or videos on for example helping promote social communications with users.

FIG. 4b illustrates in another embodiment of the invention another screen presented by the facilitator area 234, and more specifically a further screen presented by the system of the present invention that enables a parent to further establish child related settings, including adding other children.

FIG. 4c illustrates another representative embodiment of the invention, another screen of the facilitator area 234, and more specifically a screen that enables a parent to further establish child related settings. FIG. 4c shows that facilitators may define additional settings, including for example selecting the child's aptitude level, applicable audio settings and so on. It should be noted that the present invention contemplates that while the parent may define certain settings related to the operation of the invention, the administrative utility may permit the user to override these settings. For example, while the facilitator will initially configure the settings defining the parameters of the social communication landing page 236, such as colour, layout and so on, the child may be permitted to override these elements and redesign his/her room. FIGS. 4d, 4e, and 4f illustrate further screens that enable the facilitator to define settings for users.

FIG. 4g illustrates a further screen presented by the system of the present invention, and more specifically a further screen presented by facilitator area 234, and namely one or more functions that enable a facilitator to upload and public one or more photos to the user's social; communication landing page 236. The screen shown in FIG. 4f is also illustrative of functions made available in the facilitator area 135 for video.

It should also be understood that the application server 200 includes or is linked to a logger utility 242 that is operable to log all activities of any user 102 or facilitator 104 in order to monitor activities and also to dynamically adjust one or more functions of the social networking environment 100 based on the historical activity data logged for exampled to the profile of the user in the member database 210, and also based on one or more operations of an analytics utility 244 that may also be part of or linked to the application server 200. The analytics utility 244 may for example be operable to modify the permitted number of friends permitted within the social networking environment 100 to a particular user based on their then current social communication behaviour status. The analytics utility 244 may also be linked to a semantic engine 246 that is operable to analyze semantically, for example the entries to their room by a user. The output of the semantic analysis may enable the analytics utility to better establish the current social communication strengths and weaknesses for a particular user 102, and based on this one or more aspects of the functions or features of the social networking environment 100 as presented to the user may be modified, or a trigger may be initiated for obtaining or advising help for the user in one or more areas, or sending a message via the system to the facilitator 104.

### Content

As mentioned earlier, the social communication landing page 236 may include or linked to a variety of digital content.

In another aspect of the invention, the system of the present invention may be used to deploy specialized content, for example novel digital content that is designed to generate user interest, for example digital content that designed to interest children on the autism spectrum.

Video learning is often employed for children with autism, however, prior art video learning content generally includes too much auditory information for children with autism to process. Furthermore, prior art video learning content often has a “therapy” look and feel and is not “cool”. In one aspect of the invention, the social communication landing page 236 is used do distribute video content that is content that is designed to be visually clean and appealing, and therefore is likely to appeal to children on the autism spectrum.

Also other aspects of the social communication landing page 236, certain features associated with this page may be configured based on validated scientific research for enabling social communication or learning or other objectives in users. For example, communication platform features may be adjusted to suit children on the autism scale, which may involve for example slowing down messaging operations to reduce stimuli, and thereby avoid over-stimulation.

Content distributed via the social networking environment 100 may extend to topics of interest and assistance to the users, for example videos regarding important issues like bullying, self-regulation and self-advocacy. These topics are presented in a visually beautiful way, making the concepts tangible and offering the kids an opportunity to take ownership of the concept covered. The vide content, for example, is designed to build the self-esteem and confidence of the children.

The member database 210 contains profile information for each of the members in the online social network managed by the system 100. The profile information may include, among other things: a unique member identifier, name, age, gender, location, hometown, references to image files, listing of interests, attributes, and the like. The profile information also includes VISIBILITY and CONTACTABILITY settings. The relationship database 220 stores information defining to the first degree relationships between members. The relationship database 220 stores information relating to the first degree relationships between members. In addition, the contents of the member database 210 are indexed and optimized for search, and stored in the search database 230. The member database 210, the relationship database 220, and the search database 230 are updated to reflect inputs of new member information and edits of existing member information that are made through the computers 500.

### Social Networking Functionality

It should be understood that various aspects of the invention may be enhanced using state of the art social media functions and techniques, in a manner that is known. Also, the features associated with the system of the invention may be enhanced using one or more third party resources, for example a remote data source that pulls recent articles on topics of interest to parents, for example up to date and scientifically validated articles on supporting and encouraging children on the autism spectrum in development their social communication skills.

To this end, the application server 200 may be configured to manage information feeds from one or more remote computers 250.

Also, it should be understood that the application server may implement various known social media features. For example the application server 200 may be linked to one or more graph servers 300, which receive queries a query from the application server 200, processes the query and returns the query results to the application server 200. The graph servers 300 are operable to manage a representation of the social network for the various users, and to store the same in the member database 210. The graph servers 300 may have a dedicated memory device 310, such as a random access memory (RAM), in which an adjacency list that indicates all first degree relationships in the social network may be stored.

The graph servers 300 may be configured to respond to requests from application server 200 to identify relationships and the degree of separation between members of the online social network. The application server 200 may also be further configured to process requests from a third party application 320 to provide social network information (e.g., the relationships between individuals) for user records maintained in a third party database 330. The third-party application 320 makes the requests to the application server 200 through an application programming interface (API) 340. This enables third party applications to be designed and, if authorized by the operator of the system of the present invention, connect with the social networking environment 100. This may enable third parties to develop compatible functionality which may be linked to resources provided by the social networking environment 100. For example, parental resources made available through the social networking environment 100 may be enhance using one or more third party platforms or applications 320, connecting through the API 340.

The API 340 provides application developers with a set of methods, method signatures, data structures, and the like that expose an interface used by the third party application 320 to communicate with the application server 200. Application developers use the methods defined by the API 340 to construct applications that can communicate with the application server 200. There are many programmatic and syntactical choices to define the API methods that will effectively encapsulate the data and operations that are used in the invention. Thus, specific API methods, routines and data structures described below are illustrative in nature and are neither limiting nor definitive of the API 340.

### Further Details of Implementation

The present invention, in one aspect thereof, may be implemented as a computer program. Server application software implementing the features described herein, databases may execute on both centralized computers and distributed, decentralized systems. The Internet or any other private or public network (for example a company's intranet) may be used as the network to communicate between the centralized servers and the various computing devices and distributed systems that interact with it.

The use of the web server, or client-side software program, and the processing server may provide a means for distributed computing benefits, for example hosted application service provider (ASP) processing models or software-as-a-service (SaaS) application delivery models. Under these models, a third party may offer an E learning platform for several entities to use to load their teaching content, create courses, and promote and deliver their teaching content to students.

The present invention may also be operable over a wireless infrastructure. Present wireless devices are often provided with web browsing capabilities, whether through WAP or traditional means. As mentioned above, it may be preferable for users 102 who are children on the autism scale to interact with the system from a user device 110 that is a desktop computer, however, parents for example may interact with functions of the application server 200 using a mobile device for example. Functions such as monitoring of user communications by facilitators may be provided using wireless devices.

### Business Model

The social media engine of the present invention may be linked to an advertisement utility (406) (as shown in FIG. 2), which in turn may be linked to an ad network. The advertisement utility (406) may be configured to filter ads so that ads are placed within the social network in a way that would not be disruptive to users 102, because of certain parameters associated with social communication obstacles or otherwise. One aspect of the business model is the generation of ad revenue in this way.

Access to the social network or selected features or resources that are part of the social network may be provided on a subscription basis.

In another aspect of the business model of the present invention, corporate sponsors may sponsor selected social network features, or the user areas of groups of users 102.

### Advantages/Benefits of Particular Embodiments of the Invention

Numerous of the advantages of the invention have already been highlighted.

Children with autism who are mainstreamed are treated the same as other children even though they are different. This in many ways is positive, but it is also important for children for example to be able to connect to share experiences with other children who have autism. The present invention provides a safe place for these interactions to occur

Also based on the innovative role given to facilitators in the social networking design of the present invention, children with autism who initially may be reluctant to participate in social communications, can be given a head start by those who know them best, their parents for example. The parents may be informed by their personal knowledge of their children, and also the guidance provided using one or more resources made available to them by operation of the facilitator area described.

The system of the present invention may be configured to adjust the content provided to facilitators, to users, and in fact the nature of the social communications may be dynamically adjusted based on progress of the users relative to one or more goals including therapy goals.

While the social networking environment is configured in an innovative way to promote therapy objectives, the social media metaphor, features and designs that underlie the social media platform of the present invention fit well with the technology savvy user base, and the desire of children to access something that is “cool”, while addressing the way in which they best process information, in particular information presented in a digital media format.

Prior art methods usually involve pairing up children with their peers because they both have autism, not because they share common interests or even experiences. The autism spectrum is incredibly vast and affects different kids in different ways, so this current social skills model often falls short in understanding the needs of each individual child. The present invention enables matching children that are close to one another on the autism spectrum.

Social opportunities for children with autism usually occur outside the home and require the children to contend with all sorts of sensory situations based on the location of the group meeting. Many of these locations have florescent lighting, new smells, and require a lot of auditory processing—all of which are big hurdles and counter-intuitive to the processing needs of children with autism.

Children with autism are often very comfortable using a computer. Their ability to communicate is absolutely enhanced by the visual stimulation and the use of typing versus speaking and the special design aspects of the platform of the present invention raise sensory factors that have been discovered to be conducive to encouraging social communications in individuals with social communication obstacles including:
A) Almost all information is processed visually;
B) A soundtrack is associated with the social communication landing page so as to offer an auditory stimulation that is soothing;
C) The look and feel of the Squagpad™ itself is clean and beautiful (it was designed by an architect to simulate natural light coming through an open window);
D) The children are given a place to type ideas about themselves rather than speak them, and they can engage with their peers from the comfort of their own home.

In contrast, the social networking environment of the present invention enables the encoding of the current progress of the child through the social communication landing page and also the facilitator dashboard. Parents and children can change their settings as often as they like, keeping the experience dynamic and scalable. Parents have access to all of the data from the reporting section of their dashboard.

The present invention eliminates outside noise by simulating a sun-lit room with visual simplicity and clean animation. We've removed the distraction of pop-ups and advertising and designed intuitive Squagpads™ where users can focus on building a sense of self and creating friendships.

The present invention makes the communication between parent and child visual, offering a new and fresh way to encode meaning and log accomplishments.

The social media environment of the present invention makes the communication between kids easier by giving them the framework of special interest (determined by the child) and the framework of the matching software (determined by the parent).

We believe that being able to do this every day, during their downtime from the comfort of their own home will empower these kids and let them know they are not alone, and make them more confident with the idea of friendship, improving their self-esteem and ability to advocate for themselves in their daily life.

### Further Explanation of the Social Communication Landing Page Design

The design of the social communication landing page is novel and innovative per se. It enables parents to encode the provided visual space with meaning, in a way that enables the child to build a sense of self, and that inspires confidence and therefore inspires the child to engage with the environment further, and therefore engage in social communication.

For example a parent from the facilitator area may create the following message, which is automatically presented within the social communication landing page illustrated:

Ben is an amazing cook. His sisters love his pancakes.

When Ben arrives in his Squagpad™, he can actually see himself in the mirror, and his parent's message is just beside it. He is encouraged to add into his child content bubble:

I think I'm really good at cooking.

This visual representation of his strengths would be seen by him whenever he entered into his Squagpad™. This model is used all over the Squagpad™, where parents seed positive messages, present visually but in a simple, uncluttered interface. This has been found to inspire children to mirror the mood of these thoughts with their own thoughts, building a level of comfort with electronic communications. The parents of course know the particular themes or messages likely to provide just this kind of encouragement.

The pillow for example that may be presented in the social communication landing platform, based on a user interface metaphor of their room, is where children are encouraged to hope, wish, dream and set goals based on their parents' encouragement.

The laptop represented as part of the same room is where children may be given a “note in a lunch box” type of greeting from their parent to mark an important event. The laptop will also stream pre-vetted videos, original Squag™ content videos (mentioned above), video messages from their parents or other known relatives, a music composition application application, a typing program as well as email stream to Squag™ mentors and/or questions to our staff.

The photo album that may be made part of the room is where children can see family photos from their parents and recall past memories. In a full version of the social networking environment, the picture frames on the wall of the child's room may also serve as a portal to any number of pre-vetted photos, where the child can select photos and then organize photos between albums represented by each picture frame, based on special interest of the child, again encoding sense of self and establishing strengths from which they can reach out to a peer.

As a particular embodiment of the invention, the system may enable for example the creation of a baby book by the parents. This can show the children how far they have come.

In another particular embodiment of the invention, the social communication landing page depicts one or more representations of books. The child may remove these by operation of the GUI presented by the social communication landing page to for example read and write in a journal. A graphical link may also be provided to an application that may be used construct a graphic novel to encode specific accomplishments and experiences. In another particular embodiment of the present invention, a graphical link is made to a data entity referred to as a “worry book” where the child has an opportunity to record negative thoughts, ruminate on them for a determined amount of time and then let them go (this has been proven to be therapeutic for kids who suffer from OCD and anxiety for example).

In yet another embodiment of the invention, the social communication landing page may be linked to a music player application. The music player application may enable the facilitator(s) to upload music that the child likes and also provide the ability to the children to identify themselves through their taste in music. As stated above, the system of the present invention may be linked to third party applications 406, and in one particular embodiment the music player application may linked to third party application 406 for the purposes of accessing music streams, or music download services.

In another particular embodiment of the invention, the cell phone shown in the social communication landing page may enable users 102 to find past friends obtained through the system if they're currently online.

The lamp shown in the depiction of the social media landing page may enable the child to modify the lighting of the room and opacity of the color in the room, appealing to their light sensitivity.

In yet another aspect of the invention, the graphic element depicting a mirror gives the child an to really see themselves, create original thoughts about themselves, their likes & dislikes, their strengths and current mood.

### Further Implementations

It will be appreciated by those skilled in the art that other variations of the embodiments described herein may also be practiced without departing from the scope of the invention. Other modifications are therefore possible. It should be understood that the present invention may be implemented in a number of different ways, using different collaborative technologies, data frameworks, mobile technologies, web presentment technologies, content enhancement tools, document summarization tools, translation techniques and technologies, semantic tools, data modeling tools, communication technologies, web technologies, and so on. The present technology could also be integrated into one or more of such third party technologies, or such third party technologies could be modified to include the functionality described in this invention.

Several embodiments are specifically illustrated and/or described herein. However, it will be appreciated that modifications and variations are covered by the above teachings and within the scope of the appended claims without departing from the spirit and intended scope thereof. Various embodiments of the invention include logic stored on computer readable media, the logic configured to perform methods of the invention.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

1. A computer implemented system for enabling social communications involving one or more individual with social communication obstacles comprising:
(a) one or more computers including or being linked to a server computer, the server computer implementing a server application, the server application being in communication with one or more electronic communication devices;
(b) the server application being operable to define a social networking website that defines a facilitator area associated with one or more facilitators, and at least one social communication landing page associated with one or more users, in which the facilitator area enables the placement of content by the one or more facilitators into the social communication landing page, and guidance and monitoring of social communications by the one or more users with one or more other users associated with the social networking website;
(c) the server application further defining a matching utility that is configurable by the one or more facilitators from an electronic communication device so as to define one or more filters for matching the one or more users with one or more other users of the social networking website who may be compatible to elicit social communications with the one or more users.

2. A computer implemented system for promoting social networking communications involving one or more users facing social communication obstacles comprising:
(a) one or more computers including or being linked to a server computer, the server computer executing a server application, the server application being in communication with one or more electronic communication devices;
(b) the server application defining one or more social networking Internet sites (“social networking site”) that include a facilitator area accessible to the one or more facilitators, wherein the server application:
(i) enables the one or more facilitators to place content for the one or more users in a social communication landing page
(ii) enables the one or more facilitators, using a matching utility, to manage the matching of the one or more users to a set of other users with whom the one or more users may be compatible for engaging in social communications (“matched users”); and
(iii) enables the one or more facilitators to monitor activities of the one or more users through the social networking site, and if it is determined that this is advisable, guide the engagement of the one or more users with the matched users, using social networking communications;
wherein the server application permits the one or more facilitators to provide a facilitated social networking experience to the one or more users.

3. The system of claim 1, wherein server application includes or is linked to a profile manager, wherein the profile manager maintains for each user a profile that includes information based on at least one assessment or diagnosis of the user that is relevant to social communication or user of social networking.

4. The system of claim 1, wherein the assessment or diagnosis is based on placing the user on an autism scale.

5. The system of claim 2, wherein the system implements one or more rules for promoting objectives regarding social networking communications (including increased comfort levels with social networking communications), dependent on the assessment or diagnosis for the one or more users.

6. The system of claim 4, wherein the system is configured to adapt:
(a) the content;
(b) social networking features or functions; or
(c) matching functions;
based on monitoring the activities of the one or more users, and applying the rules.

7. The system of claim 1, wherein the system permits the one or more facilitators to manage a curated Internet area where the one or more facilitators can post positive messages that instill positive feelings for the one or more users.

8. The system of claim 1, wherein the server application implements one or more features that enable the one or more facilitators to post content that is familiar to the one or more users.

9. The system of claim 1, wherein the system permits the tuning of matching operations of the matching utility including based on common interests, age, gender, whether the user uses a label for their diagnosis, or whether the user uses the system with a caregiver or independently.

10. The system of claim 1, wherein the one or more facilitators may include a therapist.

11. The system of claim 4, wherein the rules include the requirement that certain changes intended by a facilitator, optionally depending on the profile of the user, requires approval by a therapist user of the system.

12. The system of claim 4, wherein the rules are based on validated scientific research for promoting social communication or learning objectives in users.

13. The system of claim 11, wherein the system adapts the content or messaging operations to reduce stimuli to avoid over-stimulation or anxiety in the one or more users.

14. The system of claim 1, wherein the system:
(a) analyzes the social communications of the one or more users; and
(b) provides one or more reports to the one or more facilitators regarding the social communications of the one or more users.

15. A computer implemented method of promoting social networking communications of one or more users who face social communication obstacles comprising:
(a) one or more facilitators using a server application to configure for the one or more users one or more social networking Internet sites (“social networking site”);
(b) the one or more facilitators placing content for the one or more users in a social communication landing page;
(c) the one or more facilitators using a matching utility to match the one or more users to a set of other users with whom the one or more users may be compatible for engaging in social communications (“matched users”), where the matched users consist of a finite group of users to avoid overwhelming the one or more users; and
(d) monitoring the activities of the one or more users through the social networking site, and if it is determined that this is advisable, guiding the engagement of the one or more users with the matched users, using social networking communications, so as to provide a facilitated social networking experience to the one or more users that promotes social communication or learning objectives.
